(19) United States
(12) Patent Application Publication
(10) Pub. No.: US 2015/0150412 A1
(43) Pub. Date: Jun. 4, 2015

(54) CLEANING CAPSULE

(71) Applicant: AQUIS WASSER-LUFT-SSTEM GMBH, LINDAU, ZWEIGNIEDERLASSUNG REBSTEIN, CH-9445 Rebstein (CH)

(72) Inventor: Bernd Heitele, CH-9437 Marbach (CH)

(21) Appl. No.: 14/405,777

(22) PCT Filed: Jun. 5, 2013
(86) PCT No.: PCT/EP2013/001641

§ 371 Date: Dec. 4, 2014

(30) Foreign Application Priority Data
Jun. 6, 2012 (DE) 10 2012 011 204.1

(51) Int. Cl. A47J 31/60; B65D 85/804; B65D 51/00; B65D 75/04

(52) U.S. Cl. CPC A47J 31/60; B65D 75/04; B65D 85/8043; B65D 51/002

(57) ABSTRACT

The invention relates to a container, in particular a capsule, for insertion into the receiving space for disposable containers or into the capsule receiving receptacle of a beverage machine, in particular of a coffee machine, in which disposable containers or disposable packages, in particular in the form of a capsule containing coffee, tea, chocolate, milk or milk powder, flavors, concentrates or other beverage base materials, are used. It is characterized in that the container includes a cleaning agent for cleaning at least part of the beverage machine.

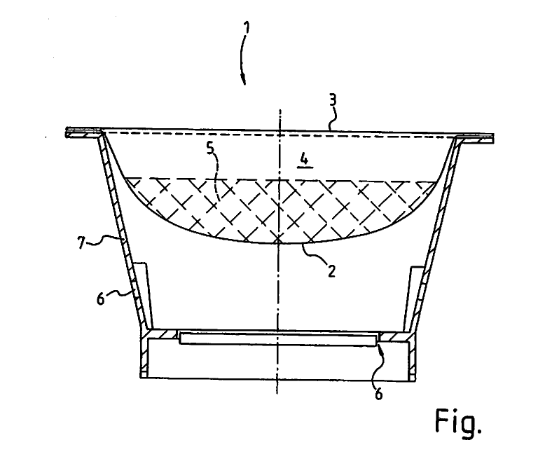

The present invention relates to a container with cleaning agent for beverage machines according to claim 1 as well as to a method for cleaning beverage machines according to claim 22.

### PRIOR ART

Beverage machines, in particular coffee machines, in which disposable containers or disposable packages are used, e.g. in the form of capsules, so-called beverage capsules, filled with coffee, tea, chocolate, milk or milk powder, flavors, concentrates or other beverage base materials, are known for preparing beverages. Said machines are designated, for example, as capsule systems.

Said disposable containers are introduced into the so-called capsule systems and are flowed through by water or an aqueous solution, the content being extracted or dissolved at the same time and dispensed as a finished beverage.

A problem with the conventional capsule systems is that the container receiving receptacle or capsule receiving receptacle as well as the dispensing channels and spaces in the machine that are contacted by the beverage become dirty in time on account of their mostly angular geometry.

The spaces of the capsule systems that are contacted by the liquid have, consequently, to be cleaned regularly with a cleaning solution.

This occurs in the case of said beverage machines with a water tank, for example, in that the water tank is filled with a cleaning liquid or a cleaning agent is dissolved in the water of the tank and then the contents of the tank are pumped over the capsule receiving receptacle and over the dispensing channels for the beverage. In the case of simple machines, the cleaning liquid, as a rule, is pumped through the machine as a result of the repeated pressing of the product button. It is then necessary to clean the tank in order to remove cleaning agent residue. The tank is then filled, as a rule, with fresh water again for this purpose and this is then pumped through the machine.

To this is added that the flushing out of the cleaning liquid requires large amounts of rinsing water over the entire hydraulics of the machine and is susceptible to error.

WO 2012/019902 proposes the use of a capsule filled with cleaning agent and/or decalcifying agent.

Consequently, the object underlying the present invention is to improve said prior art, in particular to propose a universally applicable cleaning concept.

To achieve said object, a container according to claim 1 and a method according to claim 21 are proposed.

Further expedient realizations are provided in the dependent claims.

According to the invention, it is consequently proposed to provide a cleaning container, for example a cleaning capsule, which makes inserting cleaning agent as liquid or as water-soluble solid matter into the automatic capsule machine, for example into the tank of the automatic capsule machine in a separate or free manner superfluous.

To this end, it is proposed according to the invention to use a container, for example, a capsule which makes it possible to wet the interior of the container receiving receptacle or capsule receiving receptacle and/or the dispensing channels of the machine with cleaning liquid and to clean them of residue.

In order to ensure full wetting of the container receiving receptacle or capsule receiving receptacle, the cleaning container or the cleaning capsule has a smaller outside diameter compared to the beverage capsule, e.g. coffee capsule, for example caused by a more pronounced conicity. On the outside diameter and/or in the bottom region of the container or the capsule, holes are admitted which make it possible for cleaning liquid (cleaning agent mixed with water or hot water) to flow out and in a preferred manner to spray out under pressure. The diameter of the holes, in a preferred manner, is between 0.2 and 0.6 mm and in a preferred manner 3 to 20 holes are admitted on the circumference and 1 to 8 on the bottom.

Conceivable as cleaners are liquid cleaning agents, granulated cleaning agents, cleaning tablets, cleaning foams and other conceivable states and combinations of cleaning agents. For a sufficient shelf life and storage stability of the cleaning container or of the cleaning capsule and in order to prevent direct contact between the user and the cleaning agent, the cleaning agent, irrespective of a liquid or solid state, can be enclosed in a tight manner inside the cleaning container. In this connection, a tight enclosure is to be understood as an enclosure of the cleaning agent in the container or in the capsule that is at least free of any discharge. Where liquid cleaning agents are used, at least a liquid-tight and/or vapor-tight enclosure of the cleaning agent is understood.

To this end, the cleaning agent can be enclosed, e.g. sealed, between a first and second film. The first film is initially formed for example as a result of a deep-drawing process such that an indentation or inverted dome is created for the receiving of the cleaning agent. Said deep-drawn film is connected in a preferred manner to the body of the container or capsule at the upper edge. This can occur as a result of a hot embossing method, as a result of ultrasound welding, as a result of bonding or the like. The indentation is then filled with cleaner and sealed with a second film, in a preferred manner an extensively flat film. The second film can be applied, for example, as a result of thermal welding (hot embossing method), ultrasound or the like. Instead of a film, plastics material injection molding parts and/or deep-drawn parts, metal-clad films and/or other sealing media or combinations thereof are also conceivable. All types of sealing media are designated below by way of foil.

An exemplary embodiment is explained below by way of a figure.

The wetting of the cleaning agent container or the cleaning agent capsule 1 is conceivably simple: The cleaning agent container is placed into the machine like a coffee capsule and the closing mechanism is actuated. During closing, the second film 3 is opened by a penetration device, e.g. a blade or a mandrel, or the like. The cleaning is then triggered, for example as a result of pressing a cleaning button, or triggering a beverage preparation or in a further-developed realization of a machine as a result of triggering a programmed cleaning operation. In this case, water penetrates through the perforated film 3 into the cleaning agent space 4 of the container 1 and dissolves or is mixed with the cleaning agent 5. The resultant cleaning liquid is initially not able to escape on account of the closed first film 2. However, the pump pressure of the capsule system is so high that the first film 2 tears from a certain overpressure and the cleaning liquid emerges from the container 1 and floods the interior of the container receiving receptacle or the capsule receiving receptacle through openings 6 in the housing 7 of the container 1. After a predefined contact time, for example between 1 and 2 minutes, for example as a result of pressing a cleaning button again or triggering a further beverage preparation or in a further-developed realization of a machine as a result of controlling a programmed cleaning operation, a larger amount of water of, for example, between 80-200 ml, is rinsed, as a result of which cleaning liquid residue is flushed out. The used cleaning container 1 or cleaning capsule can be ejected like a normal beverage capsule by opening the closing mechanism.

### LIST OF REFERENCES

1 cleaning agent container or cleaning agent capsule
2 Closing means/film
3 Closing means/film
4 Cleaning agent space
5 Cleaning agent
6 Openings
7 Housing

What is claimed is:

1. A container (1), in particular a capsule, for insertion into the receiving space for disposable containers or into the capsule receiving receptacle of a beverage machine, in particular of a coffee machine, in which disposable containers or disposable packages, in particular in the form of a capsule containing coffee, tea, chocolate, milk or milk powder, flavors, concentrates or other beverage base materials, are used, wherein the container includes a cleaning agent (5) for cleaning at least part of the beverage machine, characterized in that the cleaning agent is enclosed in a tight manner between a first film (2) and a second film (3).

2. The container as claimed in claim 1, characterized in that the cleaning agent is provided for cleaning the interior of the container receiving receptacle or the capsule receiving receptacle and/or the beverage dispensing channels of the beverage machine.

3. The container as claimed in claim 1 or 2, characterized in that the cleaning agent is enclosed in a tight manner and/or in a liquid-tight manner and/or in a water vapor-tight manner in the container.

4. The container as claimed in one of the preceding claims, characterized in that the cleaning agent is inserted in a tight manner in a deep-drawn inverted dome inside the container.

5. The container as claimed in one of the preceding claims, characterized in that the cleaning agent is enclosed by way of a flat cover in the container on the water intake side.

6. The container as claimed in one of the preceding claims, characterized in that said container is intended for single use for one cleaning operation.

7. The container as claimed in claim 4, characterized in that the deep-drawn inverted dome is formed for receiving the cleaner through a first film (2).

8. The container as claimed in claim 7, characterized in that the cover is formed by a second film (3).

9. The container as claimed in claim 8, characterized in that the cover is realized such that it is incised or crushed in when placed into the beverage machine so that liquid is able to ingress.

10. The container as claimed in claim 7, characterized in that the first film (2) is realized such that it is opened during the application.

11. The container as claimed in claim 7, characterized in that the first film (2) is realized such that it is opened during the application as a result of being acted upon by water pressure.

12. The container as claimed in claim 7, characterized in that the first film (2) comprises predetermined breaking points.

13. The container as claimed in one of the preceding claims, characterized in that the container is realized such that the cleaning liquid sprays out of at least 3 radially arranged holes (6) and at least one axially arranged hole (6) during the application.

14. The container as claimed in one of the preceding claims, characterized in that the effective hole diameter of a hole is less than 0.6 mm.

15. The container as claimed in one of the preceding claims, characterized in that the structural shape of the container is more conical than the beverage capsule provided for the same beverage machine.

16. The container as claimed in claim 15, characterized in that a wetting of the container receiving receptacles at least up to ⅗ of the capsule overall height is made possible as a result of the more pronounced conical structural shape.

17. The container as claimed in claim 7, characterized in that the first film (2) is opened during the application as a result of being acted upon by water pressure thanks to an aid which is inserted in the capsule, for example a mandrel, blade and the like.

18. The container as claimed in one claim 7, characterized in that the first film (2) is at a spacing predominantly from the bottom and from the walls of the container.

19. The container as claimed in claim 7, characterized in that the first film (2) is inserted in the container with at least up to 80% of its surface free of contact.

20. The container as claimed in claim 7 or 8, characterized in that the first film (2) and the second film (3) are opened together during the closure operation as a result of a penetration device when the capsule receiving receptacle is closed.

21. A method for cleaning a beverage machine, in particular a beverage machine with a receiving space for disposable containers or disposable packages, in particular in the form of capsules which include beverage base materials and/or beverage additives, wherein the following method steps are provided:
inserting cartridge with cleaning agent,
establish an access to the cleaning agent, e.g. by means of opening a closure region of a cleaning agent receiving space, in particular by incising and/or perforating a film-like closure means,
supplying water, in particular hot water into the cleaning agent receiving space, characterized by:
supplying the water mixed with cleaning agent to the parts of the beverage machine to be cleaned, and wetting the capsule receiving space to at least ⅗ of the capsule height,
where applicable allowing it to work/react
flushing out.
